(19) United States
(12) Patent Application Publication
(10) Pub. No.: US 2024/0124952 A1
(43) Pub. Date: Apr. 18, 2024

(54) METHOD FOR PRODUCING LOW-ARSENIC COPPER CONCENTRATE

(71) Applicant: NITTETSU MINING CO., LTD., Tokyo (JP)

(72) Inventors: Yousuke EBISU, Tokyo (JP); Tamaki SAITO, Tokyo (JP); Kohei MITSUHASHI, Tokyo (JP)

(73) Assignee: NITTETSU MINING CO., LTD., Tokyo (JP)

(21) Appl. No.: 18/277,852

(22) PCT Filed: Feb. 25, 2022
(86) PCT No.: PCT/JP2022/007778

§ 371 Date: Aug. 18, 2023

(30) Foreign Application Priority Data
Feb. 25, 2021 (JP) 2021-028576

(51) Int. Cl. C22B 15/00; C22B 1/11; C22B 30/04

(52) U.S. Cl. CPC C22B 15/0089; C22B 1/11; C22B 30/04

(57) ABSTRACT

In producing a copper concentrate by flotation in which copper minerals are separated from arsenic minerals by using oxoacids of sulfur and oxidants, the arsenic in the copper concentrate is reduced by a simple method. In producing the copper concentrate by the flotation in which an arsenic-containing copper ore is a raw material, the oxoacids of sulfur and hydrogen peroxide as the oxidant are used together as additive reagents, and added in this order.

### TECHNICAL FIELD

The present invention relates to a method for producing a copper concentrate by flotation using an arsenic-containing copper ore as a raw material, in particular to a method for producing a low-arsenic copper concentrate characterized in that oxoacids of sulfur and hydrogen peroxide are used together as additive reagents.

### BACKGROUND ART

There are two main methods in copper smelting. The first is a dry method in which the copper concentrate with copper sulfide concentrated is produced from ore containing naturally occurring copper sulfide, mainly by the flotation, and pyrolyzing this copper concentrate in a flash smelter or a bath furnace to obtain metallic copper. The second is a wet method in which copper is leached from ore containing naturally occurring copper oxide, copper carbonate, copper sulfate, etc., using mainly sulfuric acid, and the metallic copper is electrodeposited from this leach liquid using an electrochemical method. The former is a particularly important method accounting for more than half of the world's copper production.

The copper concentrate as the raw material for this dry copper smelting is concentration of sulfides of mainly chalcopyrite with bornite, chalcocite, covellite, etc. As a method of concentration, the flotation method is widely used. In the flotation method, air is introduced into a slurry of ground ore, and desired minerals are recovered by attaching to air bubbles and raising them. In general, this method is based on use that since copper sulfide minerals have hydrophobic surfaces, they are more stable in a slurry when attached to the air bubbles than when dispersed in liquid, and thus widely used for recovery of metal sulfide minerals, not only copper minerals, in metal mines around the world.

As properties of the copper concentrate, it is a matter of course that low impurities are required, but on the other hand, a certain degree of the impurities is often tolerated since removal of the impurities is also performed in the subsequent processes of the dry smelting. In the first place, the chalcopyrite, which is the main mineral in the copper concentrate, has a chemical structural formula of CuFeS₂ and contains iron and sulfur other than the copper. As to these components other than the copper, the iron is separated as slag in the process of the smelting, and the sulfur becomes a source of heating due to oxidation and is discharged as sulfur oxide, and later recovered as sulfuric acid. In addition, silicate components such as quartz and feldspar contained as impurities in the copper concentrate are separated as the slag, and a part of metallic components such as zinc and lead volatilize in a smelting furnace and is to be separated from the copper.

However, an impurity grade of the copper concentrate has been in a trend of increasing year by year, and there are concerns that it may interfere with processes of the copper smelting (Non-Patent Literature 1). Particularly, among the impurities, arsenic can be distributed into the slag during the processes of the copper smelting if it is below a certain amount, where it can be immobilized and insolubilized, in other words, detoxified, but when the copper concentrate containing the arsenic in excess of an allowable amount is provided in the copper smelting, it is noted that there is a risk that arsenic immobilization in the slag will become insufficient and the arsenic will be leached into environment or be released as dust.

Under these circumstances, research and development for separating arsenic minerals in production processes of the copper concentrate, i.e., in a process for producing the copper concentrate by concentrating the copper sulfide from the copper ore by the flotation, have been actively conducted in recent years.

For example, in Patent Literature 1, shown is a method for separating the arsenic minerals from copper-containing materials by adding flotation reagents containing a depressant, a frother, and a collector to a slurry composed of the copper-containing materials containing the arsenic and by performing the flotation in which air is blown into this slurry to float the copper concentrate, sodium thiosulfate being used as the depressant.

In Patent Literature 2, shown is a method for separating the arsenic minerals from the copper-containing materials after making a slurry by adding water to the copper-containing materials containing the arsenic minerals, pH of the slurry is adjusted to 8 to 12, and then the flotation is performed: wherein at least one of a soluble copper removal process that treats the copper-containing materials by using a chelating agent such as triethylenetetramine and ethylenediaminetetraacetic acid that forms a chelate with copper ions, and an oxidation process in which the arsenic minerals are subjected to oxidation treatment by using an oxidant such as air and oxygen.

In Patent Literature 3, shown is a method of using a chelating agent such as polyethylene amines as the depressant in the process that the flotation is performed by making a slurry by adding water, and adding the flotation reagents composed of the depressant, the frother and the collector to the slurry obtained, as well as blowing air, after grinding the copper-containing materials containing the arsenic.

In Patent Literature 4, shown is a method for removing the arsenic minerals by floating them as well as recovering the copper concentrate of a low arsenic grade as sink, after the copper concentrate containing the arsenic is subjected to heating treatment at 90 to 120° C., repulped, and preferably 10 to 15 kg of yellow prussiate of potash is added per 1 ton of the copper concentrate, and then the flotation is performed.

In Patent Literature 5, shown is a method for ore dressing including the process of flotation for separating sink having a higher grade of non-arsenic containing sulfide minerals than that of the raw material from froth having a higher grade of arsenic-containing sulfide minerals than that of the raw material by adding potassium amyl xanthate to a mineral slurry containing the raw material, and performing the flotation.

In Patent Literature 6, shown is a method for dressing an arsenic-containing mineral in which peptides having a specific amino acid sequence are used.

In these prior arts, however, the current situation is that while certain effects are recognized for certain ore, they are far from sufficient for efficiently and easily separating the arsenic for the ore of a wide range of properties. In addition, there are also problems that they require the use of expensive reagents, or the addition of a large amounts of reagents, etc.

### RELATED ART

### Patent Literature

Patent Literature 1: Japanese Patent No. 4450108
Patent Literature 2: Japanese Patent Laid-Open No. 2012-241249
Patent Literature 3: Japanese Patent Laid-Open No. 2011-156521
Patent Literature 4: Japanese Patent Laid-Open No. 2006-239553
Patent Literature 5: Japanese Patent Laid-Open No. 2020-104095
Patent Literature 6: Japanese Patent Laid-Open No. 2020-65485

### Non Patent Literature

Non Patent Literature 1: JOGMEC Metal Resource Report 19-06-vo149 “Research and Development on Impurities in Copper Raw Material”

### SUMMARY OF INVENTION

### Problem to be Solved by the Invention

An objective of the present invention is to provide technology for efficiently separating arsenic minerals from an arsenic-containing copper ore and producing a low-arsenic copper concentrate that can be suitably used in copper smelting, in view of the problems of the conventional technologies described above.

### Solution to Problem

In order to solve the above problems, methods proposed in the present invention are as follows.
[1] A method for producing a low-arsenic copper concentrate, wherein oxoacids of sulfur and hydrogen peroxide are used together as additive reagents in producing the copper concentrate by flotation of an arsenic-containing copper ore as a raw material.
[2] The method for producing the low-arsenic copper concentrate according to [1], wherein the oxoacids of sulfur are thiosulfates or sulfites.
[3] The method for producing the low-arsenic copper concentrate according to [1] or [2], wherein an amount of the oxoacids of sulfur added is 0.1 to 3 kg per 1 ton of the arsenic-containing copper ore.
[4] The method for producing the low-arsenic copper concentrate according to any one of [1] to [3], wherein an amount of the hydrogen peroxide added is 0.1 to 5 kg per 1 ton of the arsenic-containing copper ore.
[5] The method for producing the low-arsenic copper concentrate according to any one of [1] to [4], wherein order of addition of the additive reagents is the oxoacids of sulfur, followed by the hydrogen peroxide.
[6] The method for producing the low-arsenic copper concentrate according to any one of [1] to [5], wherein arsenic minerals contained in the arsenic-containing copper ore are enargite and tennantite.

### Advantageous Effect of Invention

According to the present invention, by a simple method of using oxoacids of sulfur and hydrogen peroxide together as additive reagents in the step of producing a copper concentrate by flotation, it becomes possible to effectively separate arsenic minerals from the copper concentrate, and to produce a low-arsenic copper concentrate that can be suitably used for copper smelting also from an arsenic-containing copper ore.

### BRIEF DESCRIPTION OF DRAWINGS

FIG. 1 is a schematic flow diagram of production of a low-arsenic copper concentrate by straight-differential flotation.

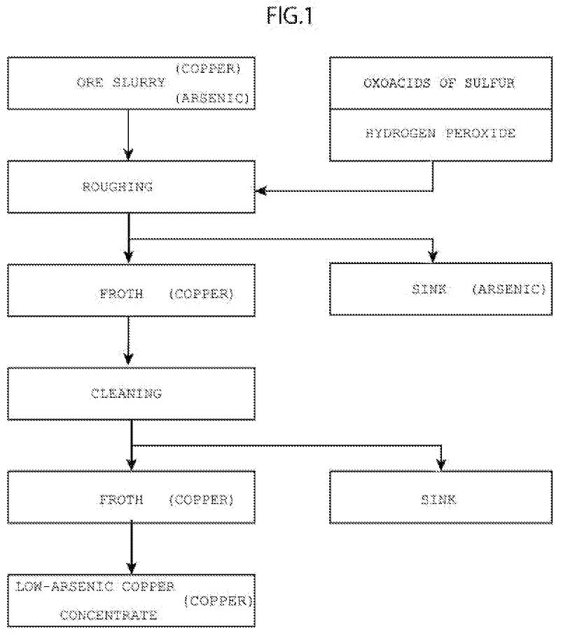

FIG. 2 is a schematic flow diagram of the production of the low-arsenic copper concentrate by bulk-differential flotation.

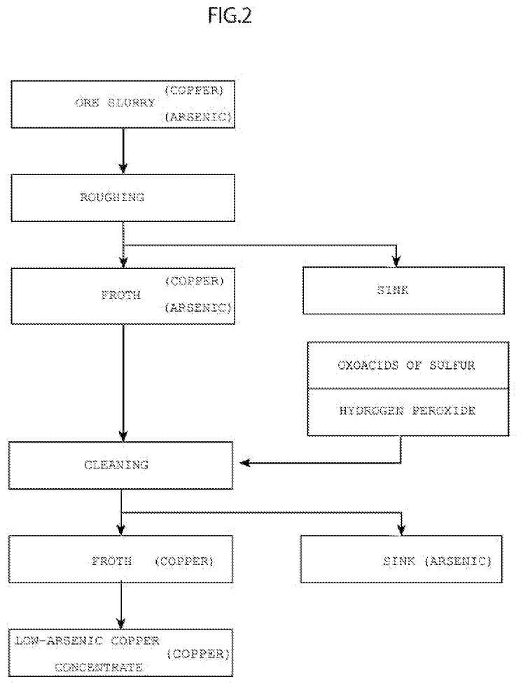

### DESCRIPTION OF EMBODIMENT

The following is a detailed description of the embodiment of the present invention.

In the present invention, when producing a copper concentrate by flotation in which an arsenic-containing copper ore is used as a raw material, a low-arsenic copper concentrate is produced by using oxoacids of sulfur and hydrogen peroxide together as additive reagents.

First, there are no particular restrictions on the arsenic-containing copper ore to be used as the raw material, and copper ores containing copper sulfide produced from porphyry copper deposits, sedimentary copper deposits, skarn deposits, massive sulfide deposits, iron oxide-hosted gold-containing copper deposits, etc., which are present all of the world may be used. Also, intermediate products of other concentrate processes and further copper concentrates may be used.

An arsenic content in the ore varies greatly depending on a type of deposit and occurrence. Generally, a copper grade in the copper ore is about 0.2 to 3 wt. %, while the arsenic content ranges from several tens ppm to more than 1% in some cases. When producing the copper concentrate by the flotation, if no measure of arsenic separation is taken, copper and arsenic are usually concentrated in similar proportions. This is due to the fact that both of copper sulfide minerals and arsenic minerals have hydrophobic surfaces, as described earlier.

An objective of a method for producing a low-arsenic copper concentrate of the present invention is to produce the copper concentrate with a reduced arsenic content by separating at least a part of arsenic minerals contained in the copper concentrate in a general flotation in which no measure is taken for arsenic reduction.

For example, looking over one example of the copper ore from the porphyry copper deposits, where the copper grade of the ore is 2.5 wt. % and the arsenic content is 0.10 wt. %, if this ore is processed by the general flotation, while the copper is concentrated to the grade of 25 wt. % (the concentration factor: 10 times), the arsenic content of the copper concentrate can reach 1.0 wt % (the concentration factor: 10 times, likewise.) In the present invention, the arsenic content in this case can be reduced to less than 1.0 wt. %.

The arsenic content in the low-arsenic copper concentrate produced in the present invention should be reduced to the arsenic content required for the copper concentrate to be used in copper smelting. An upper limit of the arsenic content required for the copper concentrate cannot be determined in general, since it varies depending on a method of the copper smelting, a blending ratio with other copper concentrate, etc., but in general, desirable is 0.2 wt. % or less.

As the copper minerals contained in the arsenic-containing copper ore, chalcopyrite (CuFeS₂), bornite (CusFeS₄), chalcocite (Cu₂S), covellite (CuS), etc. can be used without any restriction, to implement the present invention.

As the arsenic minerals, enargite (Cu₃AsS₄), tetrahedrite ((Cu, Fe, Zn)₁₂(Sb, As)₄S₁₃), mispickel (FeAsS), realgar (As₂S₂), arsenious sulfide (As₂S₃), etc. can be used without any restriction, to implement the present invention, but in particular, the enargite and the tetrahedrite are suitable arsenic minerals because they can reduce arsenic more effectively in the production method of the present invention. Although the enargite and the tetrahedrite contains copper, these arsenic minerals containing copper are simply referred to as “arsenic minerals” and the above copper minerals not containing arsenic are referred to as “copper minerals” in the present description.

The arsenic-containing copper ore mined in mines are subjected to a dry crushing step, followed by a wet grinding step, and then to a flotation step. In the method for producing the low-arsenic copper concentrate of the present invention, the oxoacids of sulfur and the hydrogen peroxide are used together as the additive reagents in the wet grinding step and/or the flotation step, to produce the low-arsenic copper concentrate.

The oxoacids of sulfur to be added can be appropriately selected from industrially available reagents, among which thiosulfates or sulfites are suitable in terms of separability of the arsenic minerals. More specifically, sodium thiosulfate, potassium thiosulfate, and ammonium thiosulfate, as the thiosulfates, and sodium sulfite, sodium hydrogen sulfite, potassium sulfite, and ammonium sulfite, as sulfites, and further these hydrates can be used.

As a form when added, it can be in the form of powder or an aqueous solution.

An amount added can be appropriately adjusted depending on a type and a content of the copper minerals as well as a type and a content of the arsenic minerals, contained in the arsenic-containing copper ore. Specifically, flotation tests are performed on a case-by-case basis, and the amount added of the oxoacids of sulfur is selected so that a recovery rate of the copper minerals and the separation of the arsenic minerals reach desired values, but more preferably, it is suitable to be 0.1 to 3 kg with respect to 1 ton of the arsenic-containing copper ore. If the amount is less than 0.1 kg, the recovery rate of the copper minerals tends to be low, on the contrary, even if adding more than 3 kg, significant effects do not appear on the results of the flotation compared with the case with 3 kg or less, and demerit of increasing costs of the reagents may occur.

For the hydrogen peroxide, it is suitable to be added as a hydrogen peroxide solution.

An amount added can be appropriately adjusted depending on the type and the content of the copper minerals contained in the arsenic-containing copper ore, as well as the type and the content of the arsenic minerals, as with the amount added of the oxoacids of sulfur. Specifically, the flotation tests are performed on the case-by-case basis, and the amount added of the hydrogen peroxide is selected so that the recovery rate of the copper minerals and the separation of the arsenic minerals reach desired values, but more preferably, it is suitable to be 0.1 to 5 kg with respect to 1 ton of the arsenic-containing copper ore. If the amount is less than 0.1 kg, the arsenic minerals tend to be easy to be recovered as froth with the copper minerals, thus the low-arsenic copper concentrate may not be obtained. On the contrary, if adding more than 5 kg, the recovery rate of the copper minerals tends to be decreased, thus economical production of the copper concentrate may not be attained.

Ball mills and rod mills are used in the wet grinding step, and to obtain a desired particle size, classifying operations by using wet cyclones, screens and the like are combined as appropriate. As to the desired particle size of the grinding, it is preferable that the copper minerals and the arsenic minerals are liberated from the aspect of separation efficiency in the subsequent flotation step.

In the flotation, various reagents are used, such as a collector to improve adhesiveness between metal minerals to be recovered and bubbles, a frother to improve foaming when air is introduced, an activator to improve a function of the collector, a depressant to prevent attachment of unwanted minerals to the bubbles, and a pH adjuster to adjust to a solution state in which the effects of the above each reagent are expressed. These are often added during the wet grinding step, and the oxoacids of sulfur and the hydrogen peroxide which are the additive reagents in the present invention can also be added in the wet grinding step.

In the wet grinding step, an ore slurry ground to the particle size suitable for the succeeding flotation stage is prepared, and sent to the flotation.

In the flotation step, after adding the various reagents to the ore slurry and treating it in a conditioning tank for stabilizing the reagents added, the ore are separated into the froth that adheres to air bubbles and sink that does not adhere to the air bubbles and remains in the slurry in a flotation machine in which air is introduced into the ore slurry. Various types of the flotation machines, such as a self-priming flotation machine, a forced-air-feeding flotation machine, and a column-type flotation machine, can be used in the present invention.

The oxoacids of sulfur and the hydrogen peroxide to be added in the present invention can be added at each location, such as in the conditioning tanks and the flotation machine in the flotation step, or in pipes and cushion tanks connecting each apparatus, in addition to the above wet grinding step. Further, the location of addition does not have to be limited to only one location, but may be multiple locations within the wet grinding step and the flotation step.

There is no restriction on order of addition of the oxoacids of sulfur and the hydrogen peroxide in the present invention, but more desirably, the oxoacids of sulfur are added first, followed by the hydrogen peroxide. For example, there are methods: the oxoacids of sulfur are added in a liquid cyclone in the wet grinding step and the hydrogen peroxide is added in the conditioning tank of the flotation step, and the oxoacids of sulfur are added in the conditioning tank and then the hydrogen peroxide is added in the flotation machine. This order of the addition enables the arsenic minerals which are objects to be separated to remain in the sink, maintaining a high recovery rate of the copper minerals to be recovered as the froth.

In the flotation step, multiple flotation machines are combined to form a flotation circuit to recover and concentrate the copper minerals which are objects to be recovered and to separate unwanted minerals. The following is a description of the flotation circuit that can be suitably applied in the present invention.

The first is straight-differential flotation. In this circuit, the copper minerals are first recovered as the froth in a rough taking step called roughing, and then the recovered material is processed into, e.g., the copper concentrate having copper grade of 25%, in a concentration step called cleaning.

When the present invention is applied to the circuit of the straight-differential flotation, the oxoacids of sulfur and the hydrogen peroxide are added during a roughing stage. As a result, the arsenic minerals and the copper minerals can be respectively separated on the sink side and the froth side during the roughing stage. Since the roughing stage is usually not sufficient to concentrate the copper grade to the level required for the copper smelting, the roughing froth is concentrated in the subsequent cleaning step.

In the cleaning stage, if separation of the arsenic is sufficient in the roughing stage, the addition of the oxoacids of sulfur and the hydrogen peroxide is unnecessary, but if the separation of the arsenic is insufficient in the roughing stage, the oxoacids of sulfur and the hydrogen peroxide are further added, to produce the low-arsenic copper concentrate with predetermined copper and arsenic contents.

When applied to the straight-differential flotation, the arsenic in the copper ore remains in the roughing sink as it is, and therefore the present invention has an advantage of not generating highly concentrated arsenic-containing materials in the flotation step, making it a suitable method for processing of the roughing sink.

Next, bulk-differential flotation is described. In this circuit, neither the oxoacids of sulfur nor the hydrogen peroxide is added in the roughing stage, and both of the copper minerals and the arsenic minerals are recovered as the roughing froth. With respect to this roughing froth, in the flotation of a next stage, the oxoacids of sulfur and the hydrogen peroxide are added, and the copper minerals are recovered as the froth, while the arsenic minerals remain in the sink.

In this method, amounts of reagents to be used can be reduced because an amount of the ore to be treated is reduced in the roughing stage and the reagents are added in the flotation of the next stage.

On the other hand, since the sink having a relatively high arsenic content is produced, attention should be paid to its treatment. However, in the case of copper-containing arsenic minerals, such as the enargite and the tetrahedrite, it is also possible to produce two types of copper concentrates, one composed of the copper minerals not containing the arsenic and the other composed of the arsenic minerals containing the copper, since both of the copper and the arsenic can be used in smelting that can properly treat both of them.

Also, if the recovery rate of copper in the roughing or cleaning stage is low, scavenging can be provided in the subsequent stage to recover the remaining copper minerals; or if the copper grade in the froth in the cleaning stage does not increase, the wet grinding step can be provided again to accelerate the separation of impurity components that are adhered to the copper minerals. In that way, there is no problem in combining the processes applied to ordinary flotation circuits as appropriate.

Properties of the arsenic-containing copper ore greatly vary depending on the type of deposit and the occurrence, and needless to say, it is desirable to select the most suitable flotation circuit and circuit configuration for each ore as appropriate.

Although details of why the arsenic content become possible to be reduced very effectively by using the oxoacids of sulfur and the hydrogen peroxide together in the present invention are not clear, it is inferred that both of the copper minerals and the arsenic minerals are oxidized by an oxidation action of the hydrogen peroxide, weakening their surface hydrophobicity, to render them unrecoverable in the flotation, but the surface hydrophobicity of only the copper minerals is maintained due to effects of the oxoacids of sulfur, as a result, the copper minerals is selectively won by the flotation maintaining the arsenic minerals recovery low.

In Patent Literature 1, disclosed is sodium thiosulfate, one of the oxoacids of sulfur, which acts as the depressant of the arsenic minerals, and in Patent Literature 2, proposed has been technology of oxidizing the arsenic minerals by the oxidation treatment using oxidants such as air and oxygen, to separate them from the copper minerals in the flotation. Though, in both of the literatures, the objective is to depress the arsenic minerals, it is inferred in the present invention that the arsenic minerals are effectively changed due to the hydrogen peroxide having an oxidation action to a state that they are difficult to be recovered in the flotation, and the oxoacids of sulfur such as thiosulfates express a role of not an action as the conventional depressant but maintaining the surface hydrophobicity of the copper minerals, that is, a mechanism newly found out by the present invention.

The low-arsenic copper concentrate produced in this way can have a low arsenic content compared with the copper concentrate produced by the flotation wherein the measures to separate the arsenic are not taken, and can be suitably used in the copper smelting.

### EXAMPLES

The present invention will be described in further detail with reference to the following Examples and Comparative Examples, but the present invention is not limited by these Examples, needless to say, is specified by the scope of claims.

### Examples 1 to 3, Comparative Examples 1 and 2

Flotation tests were performed by using Chilean arsenic-containing copper ore A having the composition shown in Table 1 as the raw material.

TABLE 1
Chemical Composition of Chilean
Arsenic-Containing Copper Ore A

| | Cu | Fe | S | As | As/Cu ratio |
|---|---|---|---|---|---|
| | wt % | wt % | wt % | wt % | — |
| Chilean Arsenic- | 2.98 | 1.73 | 2.02 | 0.14 | 0.047 |
| Containing Copper Ore A | | | | | |

First, the arsenic-containing copper ore A was crushed to −1.7 mm by a jaw crusher, and then 500 g of the ore was isolated and subjected to wet rod and ball mill grinding, to prepare a slurry of an arsenic-containing copper ore having a particle size of 180 in in 80% passage diameter. After adding water to this slurry to set the solid content concentration to 37 wt. %, various reagents listed in Table 2 were added in a conditioning step prior to the flotation, and then 10 g/t of AP3477 (dithiophosphate, produced by Solvay S.A.) as the collector and 20 g/t of MIBC (produced by Junsei Chemical Co., Ltd.) as the frother were added, and then the flotation was performed in an Agitair-type testing machine. The froth was recovered up to 16 minutes after starting of the flotation, and chemical analysis was performed on the froth and tailings, respectively. Recovery rates of the copper and the arsenic were calculated from the weight of the froth recovered and its chemical analysis values.

TABLE 2
Conditions of Reagents Addition

| | First Reagent Addition | | Next Reagent Addition | |
|---|---|---|---|---|
| | | Amount | | Amount |
| | | Added | | Added |
| | Reagent Type | g/t | Reagent Type | g/t |
| Example 1 | Hydrogen Peroxide | 330 | Sodium Thiosulfate | 1000 |
| Example 2 | Hydrogen Peroxide | 1000 | Sodium Thiosulfate | 2000 |
| Example 3 | Sodium Thiosulfate | 2000 | Hydrogen Peroxide | 1000 |
| Compar- | Not used | — | Not used | — |
| ative | | | | |
| Example 1 | | | | |
| Compar- | Sodium Thiosulfate | 2000 | Oxygen Blowing | — |
| ative | | | (4 L/minute for 10 | |
| Example 2 | | | minutes) | |

* 30 to 35 wt. % hydrogen peroxide is used as reagent. The Amount Added is the weight of the hydrogen peroxide added for 1 ton of ore.
* Sodium thiosulfate is added in its pentahydrate state. The Amount Added is the weight of the sodium thiosulfate added for 1 ton of ore.

The analysis results of the products of the flotation tests are shown in Tables 3 and 4. As clear from Tables 3 and 4, under the normal flotation condition (Comparative Example 1) in which both of the oxoacids of sulfur and the hydrogen peroxide are not added, both of the copper and the arsenic are recovered in the froth at an approximately same recovery rate, whereas in Examples 1 to 3 of the present invention, the arsenic recovery rate is suppressed to low with respect to the copper recovery rate, and the arsenic/copper ratio of the froth is lower than the arsenic/copper ratio of the sink, indicating that the arsenic grade can be effectively reduced. Furthermore, Example 3 in which the oxoacid of sulfur is added first, followed by the hydrogen peroxide, which is a more preferable embodiment of the present invention, enabled to even more effectively reduce the arsenic. In addition, even if compared with the method using the oxygen as the oxidant shown in the prior art (Patent Literature 2), it can be seen that the hydrogen peroxide of the present invention is superior.

TABLE 3
Flotation Test Results of Chilean Arsenic-Containing
Copper Ore A (Product Analysis Value)

| | Froth | | | | Sink | | | |
|---|---|---|---|---|---|---|---|---|
| | | Copper | Arsenic | As/Cu | | Copper | Arsenic | As/Cu |
| | Weight | Grade | Grade | Ratio | Weight | Grade | Grade | Ratio |
| | wt % | wt % | wt % | — | wt % | wt % | wt % | — |
| Example 1 | 10.8 | 22.5 | 0.99 | 0.044 | 89.2 | 0.31 | 0.02 | 0.065 |
| Example 2 | 17.0 | 10.5 | 0.25 | 0.024 | 83.0 | 0.78 | 0.06 | 0.077 |
| Example 3 | 11.4 | 16.0 | 0.20 | 0.013 | 88.6 | 0.94 | 0.09 | 0.096 |
| Comparative | 11.1 | 24.0 | 0.75 | 0.031 | 88.9 | 0.17 | 0.004 | 0.024 |
| Example 1 | | | | | | | | |
| Comparative | 11.1 | 18.1 | 0.64 | 0.035 | 88.9 | 1.01 | 0.03 | 0.030 |
| Example 2 | | | | | | | | |

TABLE 4
Flotation Test Results of Chilean Arsenic-
Containing Copper Ore A (Recovery Rate)

| | Froth | | | Sink | | |
|---|---|---|---|---|---|---|
| | | Copper | Arsenic | | Copper | Arsenic |
| | | Recovery | Recovery | | Recovery | Recovery |
| | Weight | Rate | Rate | Weight | Rate | Rate |
| | wt % | wt % | wt % | wt % | wt % | wt % |
| Example 1 | 10.8 | 89.8 | 83.3 | 89.2 | 10.2 | 16.7 |
| Example 2 | 17.0 | 73.5 | 45.3 | 83.0 | 26.5 | 54.7 |
| Example 3 | 11.4 | 68.8 | 21.3 | 88.6 | 31.2 | 78.7 |
| Comparative | 11.1 | 94.6 | 96.1 | 88.9 | 5.36 | 3.92 |
| Example 1 | | | | | | |
| Comparative | 11.1 | 69.1 | 75.5 | 88.9 | 30.9 | 24.5 |
| Example 2 | | | | | | |

### Examples 4 and 5, Comparative Examples 3 to 5

The flotation tests were performed using Chilean arsenic-containing copper ore B having the compositions shown in Table 5 as the raw material.

TABLE 5
Chemical Composition of Chilean
Arsenic-Containing Copper Ore B

| | CU | Fe | S | As | As/Cu Ratio |
|---|---|---|---|---|---|
| | wt % | wt % | wt % | wt % | — |
| Chilean Arsenic- | 0.94 | 0.81 | 0.58 | 0.021 | 0.022 |
| Containing Copper Ore B | | | | | |

First, the arsenic-containing copper ore B was crushed to −1.7 mm by a jaw crusher, and then 480 g of the ore was isolated and subjected to wet rod and ball mill grinding, to prepare a slurry of an arsenic-containing copper ore having a particle size of 70 lam in the 80% passage diameter. After adding water to this slurry to set the solid content concentration to 37 wt. %, various reagents listed in Table 6 were added in a conditioning step prior to the flotation, and then 50 g/t of AP3477 (dithiophosphate, produced by Solvay S.A.) as the collector and 24 g/t of MIBC (produced by Junsei Chemical Co., Ltd.) as the frother were added, and then the flotation was performed in an Agitair-type testing machine. The froth was recovered up to 16 minutes after starting of the flotation, and chemical analysis was performed on the froth and the sink, respectively. Recovery rates of the copper and the arsenic were calculated from the weight of the froth recovered and its chemical analysis values.

TABLE 6
Conditions of Reagents Addition for Chilean
Arsenic-Containing Copper Ore B

| | First Reagent Addition | | Next Reagent Addition | |
|---|---|---|---|---|
| | | Amount | | Amount |
| | | Added | | Added |
| | Reagent Type | g/t | Reagent Type | g/t |
| Example 4 | Hydrogen | 1000 | Sodium | 2000 |
| | Peroxide | | Thiosulfate | |
| Example 5 | Sodium | 2000 | Hydrogen | 1000 |
| | Thiosulfate | | Peroxide | |
| Comparative | Not used | — | Not used | — |
| Example 3 | | | | |
| Comparative | Hydrogen | 2000 | Not used | — |
| Example 4 | Peroxide | | | |
| Comparative | Sodium | 2000 | Not used | — |
| Example 5 | Thiosulfate | | | |

* 30 to 35 wt. % hydrogen peroxide is used as reagent. The Amount Added is the weight of the hydrogen peroxide added for 1 ton of ore.
* Sodium thiosulfate is added in its pentahydrate state. The Amount Added is the weight of the sodium thiosulfate added for 1 ton of ore.

The analysis results of the products of the flotation tests are shown in Tables 7 and 8. As clear from Tables 7 and 8, under the normal flotation condition (Comparative Example 3) in which both of the oxoacids of sulfur and the hydrogen peroxide are not added, both of the copper and the arsenic are recovered in the froth at an approximately same recovery rate, whereas in Examples 4 and 5 of the present invention, the arsenic recovery rate is suppressed to low with respect to the copper recovery rate, and the arsenic/copper ratio of the froth is lower than the arsenic/copper ratio of the sink, indicating that the arsenic grade can be effectively reduced. While, in Comparative Example 4 in which only hydrogen peroxide is added, both of the copper and the arsenic are equally suppressed, thereby not to be effective separation, and in addition, in Comparative Example 5 in which only sodium thiosulfate is added, which is shown in the prior art (Patent Literature 1), the arsenic reduction effect is limited, and thus in Examples 4 and 5, even more effective arsenic reduction is possible. That is, as per the present invention, it is shown that the low-arsenic copper concentrate having effectively reduced arsenic content can be produced by using both of the oxoacids of sulfur and the hydrogen peroxide.

TABLE 7
Flotation Test Results of Chilean Arsenic-Containing
Copper Ore B (Product Analysis Value)

| | Froth | | | | Sink | | | |
|---|---|---|---|---|---|---|---|---|
| | | Copper | Arsenic | As/Cu | | Copper | Arsenic | As/Cu |
| | Weight | Grade | Grade | Ratio | Weight | Grade | Grade | Ratio |
| | wt % | wt % | wt % | — | wt % | wt % | wt % | — |
| Example 4 | 14.4 | 2.22 | 0.02 | 0.009 | 85.6 | 0.76 | 0.01 | 0.013 |
| Example 5 | 14.7 | 4.39 | 0.03 | 0.007 | 85.3 | 0.37 | 0.004 | 0.011 |
| Comparative | 13.6 | 5.63 | 0.14 | 0.025 | 86.4 | 0.19 | 0.004 | 0.021 |
| Example 3 | | | | | | | | |
| Comparative | 9.12 | 4.12 | 0.12 | 0.029 | 90.9 | 0.54 | 0.01 | 0.019 |
| Example 4 | | | | | | | | |
| Comparative | 18.2 | 5.37 | 0.04 | 0.007 | 81.8 | 0.31 | 0.003 | 0.010 |
| Example 5 | | | | | | | | |

TABLE 8
Flotation Test Results of Chilean Arsenic-
Containing Copper Ore B (Recovery Rate)

| | Froth | | | Sink | | |
|---|---|---|---|---|---|---|
| | | Copper | Arsenic | | Copper | Arsenic |
| | | Recovery | Recovery | | Recovery | Recovery |
| | Weight | Rate | Rate | Weight | Rate | Rate |
| | wt % | wt % | wt % | wt % | wt % | wt % |
| Example 4 | 14.4 | 33.0 | 21.4 | 85.6 | 67.0 | 78.6 |
| Example 5 | 14.7 | 66.9 | 56.8 | 85.3 | 33.1 | 43.2 |
| Comparative | 13.6 | 82.4 | 83.3 | 86.4 | 17.6 | 16.7 |
| Example 3 | | | | | | |
| Comparative | 9.12 | 43.4 | 49.9 | 90.9 | 56.6 | 50.1 |
| Example 4 | | | | | | |
| Comparative | 18.2 | 79.6 | 72.7 | 81.8 | 20.4 | 27.3 |
| Example 5 | | | | | | |

1. A method for producing a low-arsenic copper concentrate, wherein oxoacids of sulfur and hydrogen peroxide are used together as additive reagents in producing the copper concentrate by flotation of an arsenic-containing copper ore as a raw material.

2. The method for producing the low-arsenic copper concentrate according to claim 1, wherein the oxoacids of sulfur are thiosulfates or sulfites.

3. The method for producing the low-arsenic copper concentrate according to claim 1, wherein an amount of the oxoacids of sulfur added is 0.1 to 3 kg per 1 ton of the arsenic-containing copper ore.

4. The method for producing the low-arsenic copper concentrate according to claim 1, wherein an amount of the hydrogen peroxide added is 0.1 to 5 kg per 1 ton of the arsenic-containing copper ore.

5. The method for producing the low-arsenic copper concentrate according to claim 1, wherein order of addition of the additive reagents is the oxoacids of sulfur, followed by the hydrogen peroxide.

6. The method for producing the low-arsenic copper concentrate according to claim 1, wherein arsenic minerals contained in the arsenic-containing copper ore are enargite and tennantite.

7. The method for producing the low-arsenic copper concentrate according to claim 1,
wherein in flotation, copper minerals are separated and recovered as floating ores and arsenic minerals are separated and recovered as precipitates.

8. The method for producing the low-arsenic copper concentrate according to claim 1,
wherein the arsenic mineral is oxidized by the oxidizing action of hydrogen peroxide to reduce recovery in flotation,
the oxoacid of sulfur maintains the surface hydrophobicity of copper minerals to facilitate recovery by flotation.
